(19) United States
(12) Patent Application Publication
(10) Pub. No.: US 2011/0228742 A1
(43) Pub. Date: Sep. 22, 2011

(54) Sub Channel Generation for a Wireless Mesh Network

(76) Inventors: Zhi-Chun Honkasalo, Kauniainen (FI); Zhu Yan Zhao, Beijing (CN)

(21) Appl. No.: 12/997,691

(22) PCT Filed: Jun. 15, 2009
(86) PCT No.: PCT/EP2009/057365

§ 371 Date: May 31, 2011

Related U.S. Application Data
(60) Provisional application No. 61/132,090, filed on Jun. 13, 2008.

(51) Int. Cl. H04W 72/04

(52) U.S. Cl. 370/330; 370/329

(57) ABSTRACT

In accordance with an example embodiment of the present invention, there is at least a method, apparatus, and computer program for dividing an available bandwidth into a plurality of frequency bands or channels, dividing each of the plurality of frequency bands or channels into a plurality of orthogonal sub-carriers, organizing the sub-carriers into a plurality of sub-channels, and assigning at least some of the generated sub-channels to at least one corresponding radio link between parent and child nodes of a mesh network.

### TECHNICAL FIELD

The present application relates generally to wireless communication systems, methods, devices and computer programs and, more specifically, relate to wireless mesh node networks, including those capable of providing backhaul services.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Various abbreviations that appear in the specification and/or in the drawing figures are defined as follows:
BTS base transceiver station
CDMA code division multiple access
CP cyclic prefix
DL downlink
DVB digital video broadcast
FDD frequency division duplex
FDMA frequency division multiple access
FFT fast Fourier transform
GPS global positioning system
GSM global system for mobile communication
IFFT inverse fast Fourier transform
LTE long term evolution of UTRAN (also referred to as evolved-UTRAN)
MAC medium access control
NodeB base station (an access point AP)
OFDMA orthogonal frequency division multiple access
RX receive
TDD time division duplex
TDMA time division multiple access
TX transmit
UTRAN universal terrestrial radio access network
WCDMA wideband code division multiple access
WLAN wireless local area network
WMN wireless mesh network

A significant amount of research has been performed in recent years in the area of wireless mesh networks. Of particular interest herein is a so-called “2^{nd} mile” mesh network, which may imply a synchronous wireless meshed backhaul based on high performance infrastructure wireless mesh technology.

A meshed network includes multiple mesh nodes which are able to communicate with each other over wireless links. The mesh nodes may be considered to function essentially as wireless routers. Among the mesh nodes there is at least one root node which connects with a conventional backbone or metro aggregation network (using, for example, optical fiber, cable or microwave as physical layer media for the connection). The data traffic is mainly routed between the wireless mesh nodes and backbone network through the root node(s). The root node is the traffic aggregation point of the mesh nodes. The meshed network is often organized as a tree topology structure at one specific time instant. This means that at any specific time instant, each mesh node in the tree only has one parent node. Conversely, each node may act as parent node for one or more children nodes. In other words, a parent node is the mesh node that is connecting its children nodes towards a given root node, at one particular time instant.

In general, existing WLAN-based multi-transceiver mesh networks (where individual mesh nodes have a plurality of co-located transceivers) are mainly designed to use a pure FDMA-based multi-channel scheme. This approach exhibits a number of disadvantages. In particular, a multi-channel WiFi mesh network requires a rather large spectrum to be available for deployment. For instance, IEEE 802.11a may be deployed in the 5.8 GHz unlicensed band where 100 MHz is available. If one assumes the use of five 20 MHz RF channels, a guard band of one or two channels (20 MHz each) can be made available in each mesh node between two co-located transceivers.

When designing a mesh network that uses licensed spectrum for future telecommunication networks, a spectrally efficient solution is of primary importance as it may be the case that each operator may only have, as a non-limiting example, 10 MHz to 20 MHz of bandwidth for system deployment (more generally, an insufficient amount for a WiFi type of mesh allocation). This implies that the simple FDMA-based approach, as in WiFi mesh networks, will not be adequate.

As may be appreciated from this brief introduction, a number of problems need to be addressed in order to enable the further evolution and development of wireless mesh networks, including backhaul wireless mesh networks.

### SUMMARY

Various aspects of examples of the invention are set out in the claims.

According to a first aspect of the invention, there is a method comprising dividing an available bandwidth into a plurality of frequency bands or channels, dividing each of the plurality of frequency bands or channels into a plurality of orthogonal sub-carriers, organizing the sub-carriers into a plurality of sub-channels, and assigning at least some of the generated sub-channels to at least one corresponding radio link between parent and child nodes of a mesh network.

According to a second aspect of the invention, there is an apparatus comprising a processor configured to divide an available bandwidth into a plurality of frequency bands or channels, the processor configured to divide each of the plurality of frequency bands or channels into a plurality of orthogonal sub-carriers, the processor configured to organize the sub-carriers into a plurality of sub-channels, and the processor configured to assign at least some of the generated sub-channels to at least one corresponding radio link between parent and child nodes of a mesh network

According to a third aspect of the invention, there is an apparatus, comprising means for dividing an available bandwidth into a plurality of frequency bands or channels, means for dividing each of the plurality of frequency bands or channels into a plurality of orthogonal sub-carriers, means for organizing the sub-carriers into a plurality of sub-channels, and means for assigning at least some of the generated sub-channels to at least one corresponding radio link between parent and child nodes of a mesh network.

### BRIEF DESCRIPTION OF THE DRAWINGS

For a more complete understanding of example embodiments of the present invention, reference is now made to the following descriptions taken in connection with the accompanying drawings in which:

FIG. 1 is a simplified block diagram of a multi-channel, multi-radio directional antenna based wireless mesh network;

FIG. 2 shows an example of an OFDMA based subchannel;

FIG. 3 illustrates an example of a 4-phase transmission scheme (scheme 1) using a single transceiver in each of a plurality of mesh nodes;

FIG. 4 illustrates an example of the 4-phase transmission scheme (scheme 1) in a multi-hop network;

FIG. 5 illustrates an example of a 2-phase transmission scheme (scheme 2) using a single transceiver in each of a plurality of mesh nodes;

FIG. 6 illustrates an example of the 2-phase transmission scheme (scheme 2) in a multi-hop network;

FIG. 7 illustrates an example of a 2-phase transmission scheme (scheme 3, type 1) using multiple transceivers in each of a plurality of mesh nodes;

FIG. 8 illustrates an example of the 2-phase transmission scheme (scheme 3, type 1) in a multi-hop network;

FIG. 9 illustrates an example of a 2-phase transmission scheme (scheme 4, type 2) using multiple transceivers in each of a plurality of mesh nodes;

FIG. 10a illustrates an example of the 2-phase transmission scheme (scheme 4, type 2) in a multi-hop network;

FIG. 10b illustrates an example of the 2-phase transmission scheme (scheme 4, type 2) in another multi-hop network deployment example;

FIG. 11 illustrates an example of a 1-phase transmission scheme (scheme 5, type 1) using multiple transceivers in each of a plurality of mesh nodes, as well as a multi-hop network example;

FIG. 12 illustrates an example of a 1-phase transmission scheme (scheme 6, type 2) using multiple transceivers in each of a plurality of mesh nodes, as well as a multi-hop network example;

FIG. 13 illustrates an example of a 1-phase transmission scheme (scheme 7, type 3) using multiple transceivers in each of a plurality of mesh nodes, as well as a multi-hop network example;

FIG. 14 depicts an in-band backhaul scheme wherein an access time slot and a backhaul time slot are divided by TDD;

FIG. 15 shows an exemplary hybrid FDMA and OFDMA subchannel generation method;

FIG. 16 shows a table (Table 1) that is useful in understanding the channel assignment principles of schemes 1-7 shown in FIGS. 3-13; and

FIG. 17 shows a flow chart of steps which can be taken according to the exemplary embodiments of the invention.

### DETAILED DESCRIPTON OF THE DRAWINGS

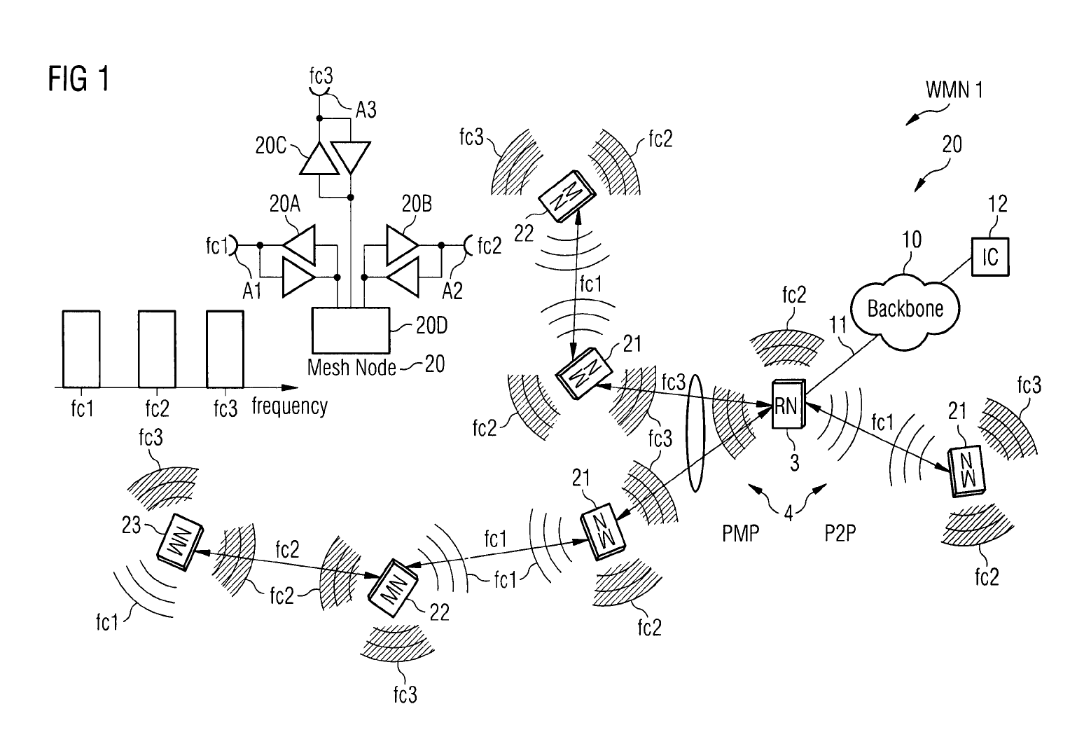

An example embodiment of the present invention and its potential advantages are understood by referring to FIGS. 1 through 17 of the drawings.

FIG. 1 illustrates mesh nodes 20 which includes node 21, 22, and 23 functioning essentially as wireless routers. As illustrated, it can be seen that these nodes comprise parent node and child node configurations. Also shown are radio connections 4 between the mesh nodes. The traffic flows up and down through the branches of the mesh network 1.

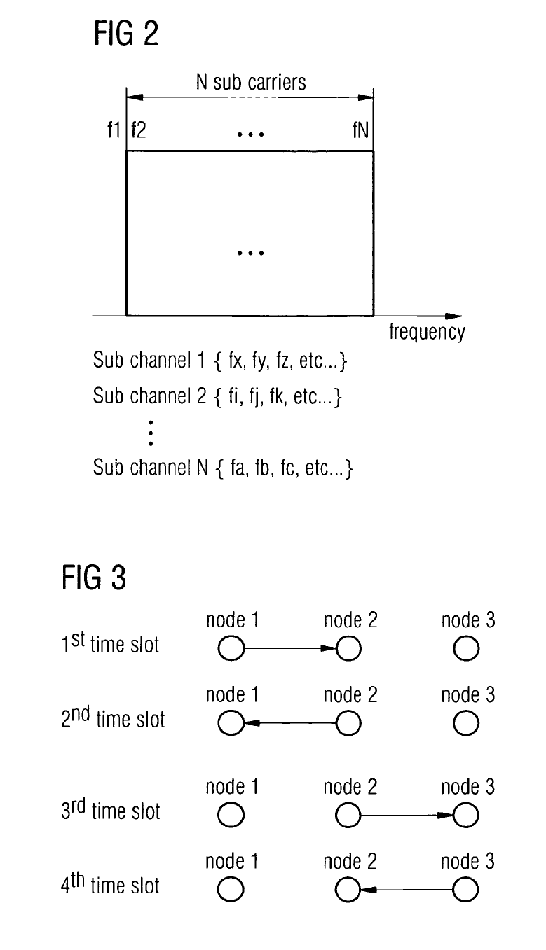

FIG. 2 illustrates an OFDMA-based multi-channel scheme. Using OFDMA the total available frequency band (or spectrum) is divided into N orthogonal sub-carriers, where N is the FFT/IFFT size used for OFDM symbols. In this case the multi-channel system can be realized through a proper combination of OFDM sub-carriers. This means that with N sub-carriers, the maximum of N sub-channels are available. According to actual network topology requirements, each radio link can then be allocated a different number of sub-carriers, and consequently a more flexible channel bandwidth allocation is realized.

FIG. 3 illustrates a transmission example of the mesh node 20 configured with one radio transceiver (e.g., 20A), where a TDD radio frame is used. Node1 is the parent node of node2, and node2 is the parent node of node3. The TDD frame is equally divided into four time phases that are allocated for the transmission from node1 to node2, from node2 to node3, from user node3 to node2, and from node2 to node1, in turn, as illustrated in FIG. 3. Since the four transmissions can have different orders in combination, the wireless mesh network 1 can adopt any of the combinations to realize data exchange according to system requirement.

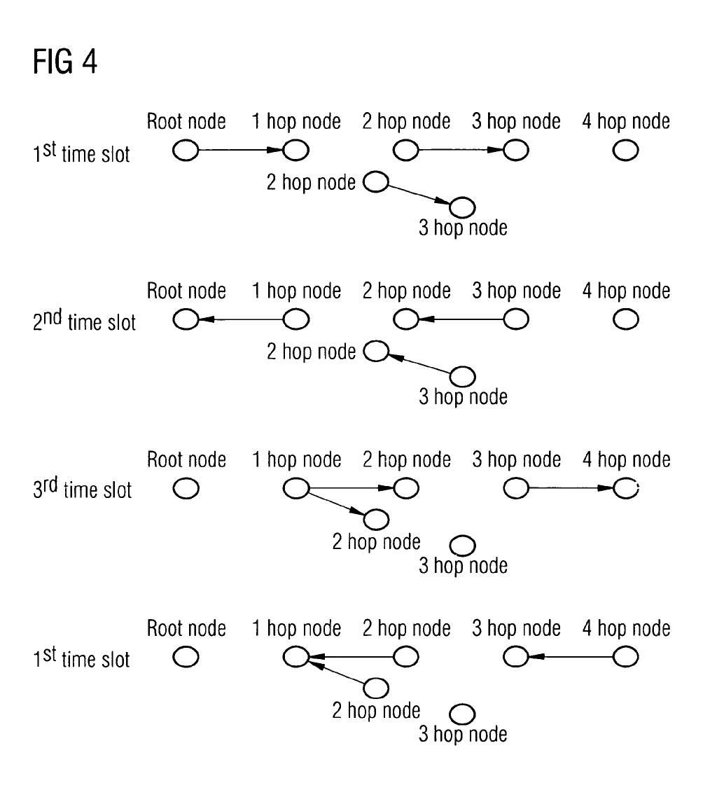

FIG. 4 illustrates an example of a similar principle, as in FIG. 3, which can be readily extended to the wireless mesh network where the maximum number of hops is larger than two. Here, the two phases of TX and two phases of RX are performed separately. Therefore, for a mesh node 20 there is no interference between these four procedures. This means in theory that a particular node 20 can complete the four communication procedures using the same sub-channels. In such a wireless mesh network one need consider the interference between different mesh nodes 20. One potential drawback to this approach, however, is that the mesh nodes 20 operate in half-duplex mode, thus they cannot simultaneously transmit and receive thereby reducing system throughput.

FIG. 5 illustrates a configuration where a 2-phase transmission protocol is used. In this configuration a time division duplex radio frame is divided into two time slots. In the first time slot, node1 transmits s1 to the mesh node2, and the node3 transmits s2 to the mesh node2. To avoid interference between the two signals, s1 and s2 use different orthogonal sub-channels. In the second time slot, mesh node2 broadcasts s1+s2 to node1 and node3. Since s1 and s2 are known to node1 and to node3, respectively, they can perform self-interference cancellation and correctly obtain the s2 and s1 information, respectively. Alternatively, mesh node2 sends s1 to mesh node 3 and s2 to mesh node 1 using different orthogonal sub-channels. Here node 2 functions in a manner analogous to a BTS connected to multiple terminals. A similar principle can be readily extended to the wireless mesh network 1, where the maximum number of hops is larger than two.

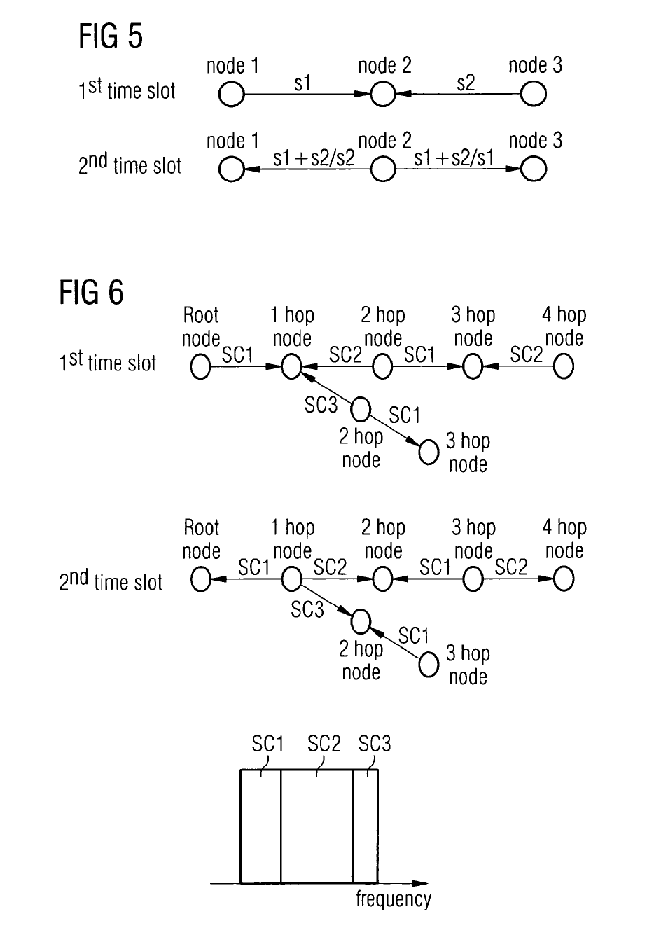

FIG. 6 illustrates an example of a sub-channel assignment for scheme 2. SC1 (sub-channel 1), SC2 (sub-channel 2) and SC3 (sub-channel 3) are generated based on OFDMA. FIG. 6 illustrates that during one time slot the transceivers of even hop nodes perform TX while all odd hop nodes perform RX. In the subsequent time slot, all of the odd hop nodes perform RX, the even hop nodes perform TX, and so on. In FIG. 6, the sub-channel assignments SC1, SC2 and SC3 are generated from the sub-carriers of the same OFDM symbol bandwidth (or RF channel). SC1, SC2 and SC3 are assigned to the corresponding radio links in order to ensure proper system operation and avoid the inter-node interference.

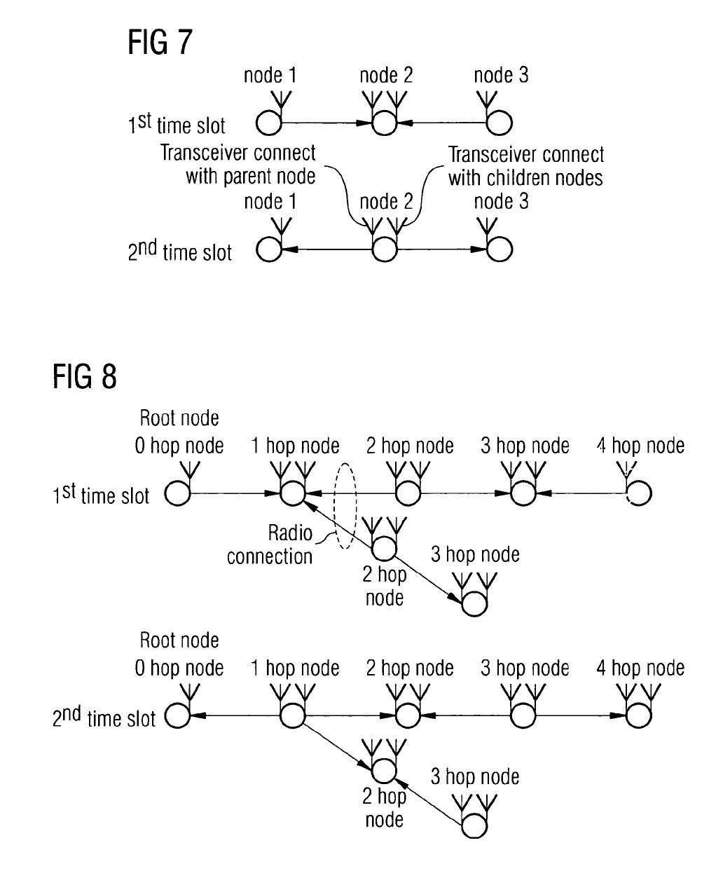

FIG. 7 illustrates a multi-hop radio system. In this system there is a multi-transceiver based 2-phase transmission type 1 and the node 2 is the intermediate node. The transceivers of the node 20 are divided into two groups, i.e., the transceivers connecting with the parent node and the transceivers connecting with child nodes. In the first time slot, all of the transceivers of node2 perform RX and receive packets from the neighbor nodes, such as the nodel and node 3 illustrated in FIG. 7. In the following time slot all of the transceivers of node2 perform TX and transmit packets to the neighbor nodes, node1 and node3 in this example.

FIG. 8 illustrates a multi-hop radio system where the maximum hop number is larger than two and the network is organized in a tree topology. In the multi-hop radio system of FIG. 8 the mesh/relay nodes 20 are divided as even hop nodes and odd hop nodes, which are determined by the hop number from the root node 3 of the tree topology. In the system of FIG. 8, for all the transceivers to connect with the parent nodes, there is half slot phase difference between the odd and even hop nodes. Similarly for all the transceivers to connect with the child node there is half frame phase difference between the odd and even hop nodes.

FIG. 9 illustrates a transmission scheme where an intermediary node, node2, receives a packet from node1 while using another transceiver to transmit a packet to node3. In the next time slot node2 transmits a packet to node1, while using the other transceiver to receive a packet from node3.

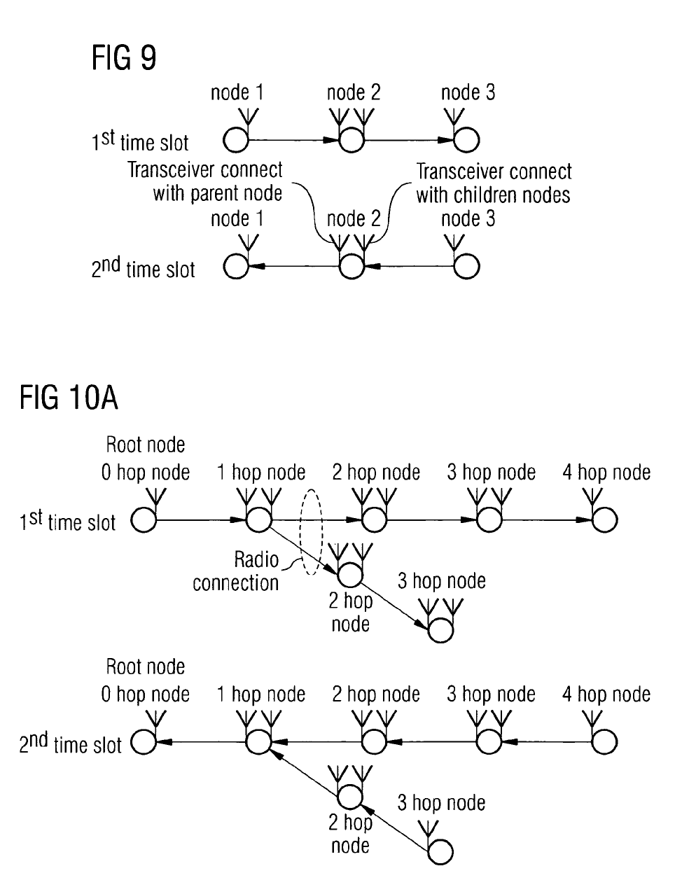

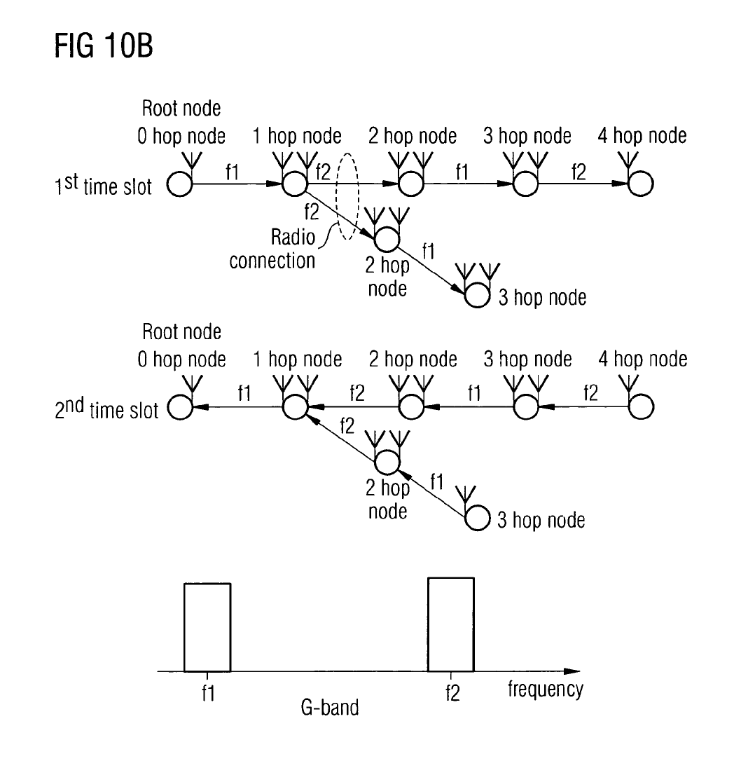

FIG. 10a illustrates a transmission scheme where the transceivers connecting child nodes and the transceivers connecting the parent node are being synchronized. This implies that the transceivers connecting parent node/child nodes perform TX/RX within the same time slot.

FIG. 10b illustrates an example a scheme deployed in a FDD spectrum. As similarly shown in the G-band graph of FIG. 10b, the frequency bands f1 and f2 have a sufficient duplex guard band (G-band). In this case f1 and f2 are assigned to mesh nodes in even hop and odd hop alternation as illustrated.

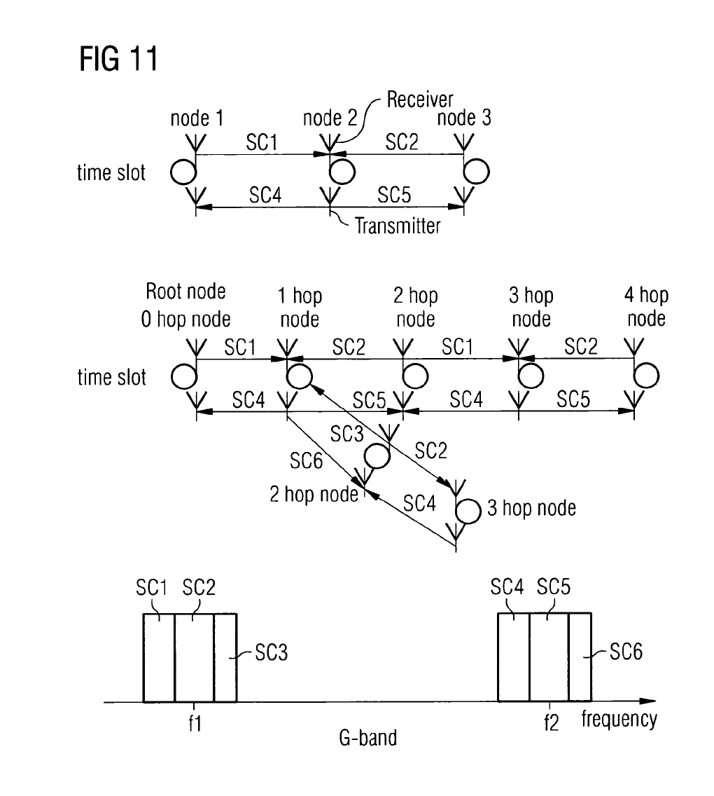

FIG. 11 illustrates a 1-phase transmission using multiple transceivers, type 1. The transceivers 20A-20C of the nodes 20, as identified in FIG. 1, are divided into two groups, and some transceivers function as a receiver and others function as transmitters. The transmitters are used to send a data packet to the parent node and child nodes, and the receivers are used to receive a data packet from the parent node and child nodes. To avoid interference between the co-located transmitter and receiver they are assigned to use different RF channels f1 and f2. Between f1 and f2 there is provided a sufficient duplex guard band. As in scheme 2, scheme 5 differentiates the signals coming from or sent to the corresponding child nodes and parent node. Sub-channels SC1, SC2 and SC3 from RF channel f1 are used to avoid interference for the receivers, and sub-channels SC4, SC5, SC6 from RF channel f2 are used to avoid interference for the transmitters.

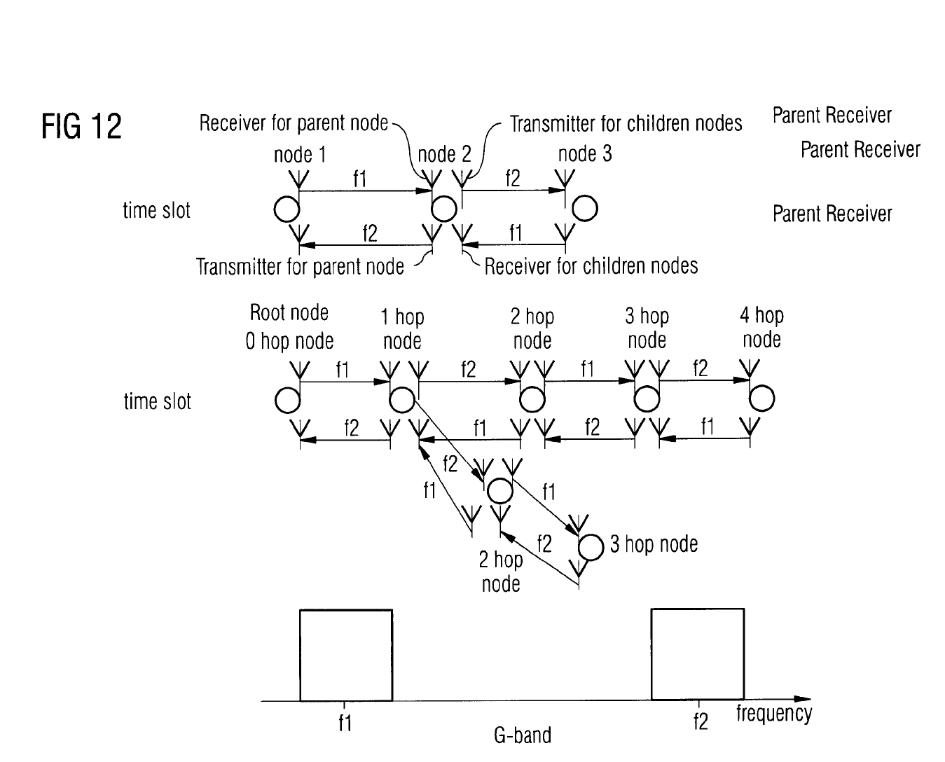

FIG. 12 illustrates a 1-phase transmission scheme, using multi-transceivers, including using two transceivers to realize the radio link with the parent node (i.e., a transmitter for the parent node and a receiver for the parent node). This transmission scheme also uses two transceivers to realize the radio link with the child node (i.e., a transmitter for the child node and a receiver for the child node).

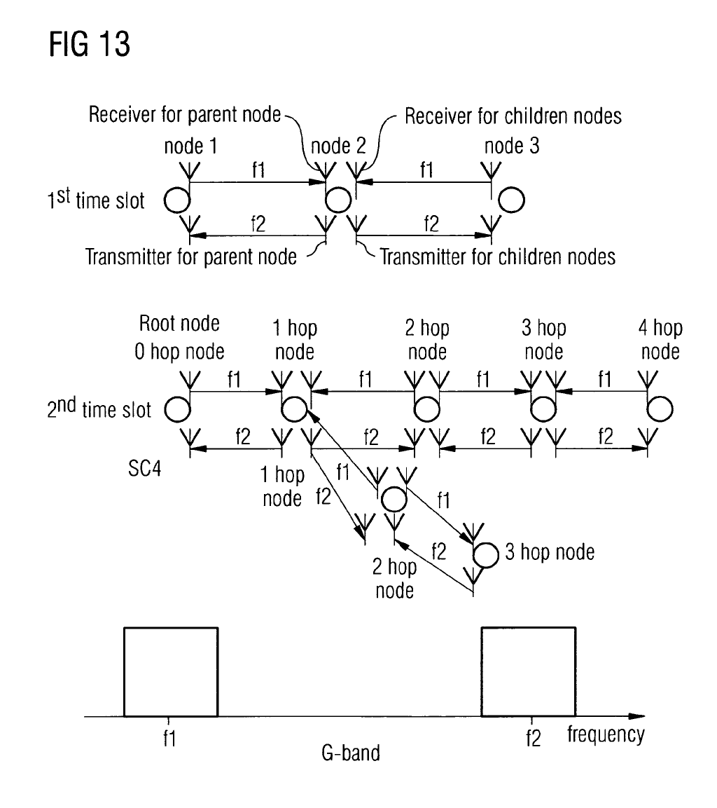

FIG. 13 illustrates a transmission scheme similar to FIG. 12. One advantage that is realized by the use of the transmissions schemes of FIGS. 12 and 13, is that with sufficient RF (spatial) isolation, any significant amount interference between different transceivers of the same node 20 can be avoided. This ensures high throughput performance of the mesh/relay node 20, even if the co-located transceivers operate in the same frequency band/same sub-channel.

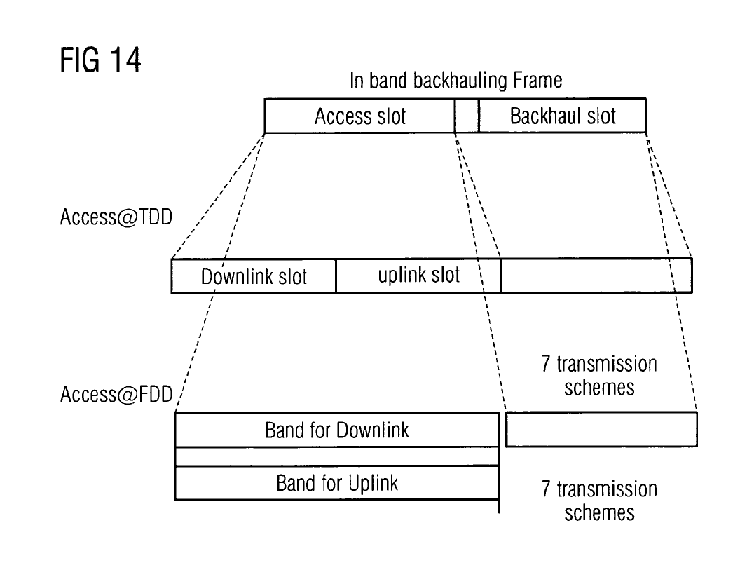

FIG. 14 illustrates an in-band backhauling frame that includes two time slots, where one time slot is used for the network access part and the other time slot is used for backhauling. In the case that the access part operates in the TDD mode the time slot used for the access part is further divided into two parts, one for DL transmission and the other for the UL transmission. In a case where the access part operates in the FDD mode the UL and DL transmissions occur in the same access time slot, but are separated by the use of different frequency bands. Consequently, the frequency band used for the access part may be the same as the frequency band used for the backhauling part.

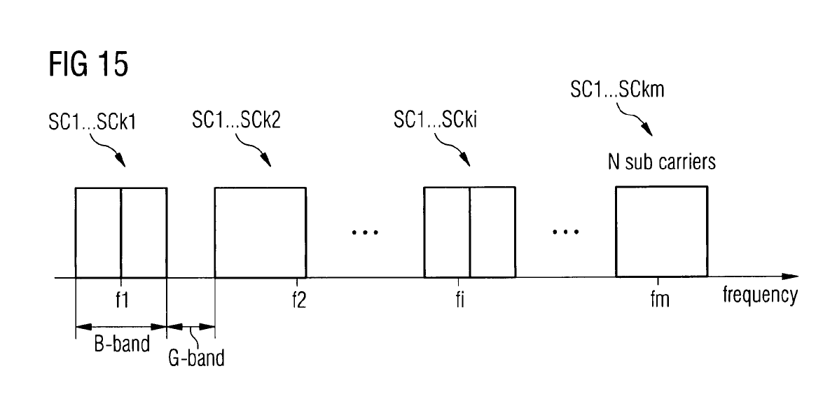

FIG. 15 shows M frequency bands (or RF channels) where the center frequency of each frequency band (channel) is shown as f1, f2 . . . fm. The guard band between neighborhood frequency bands or RF channels is denoted as G-band, and the bandwidth of each frequency band is denoted as B-band.

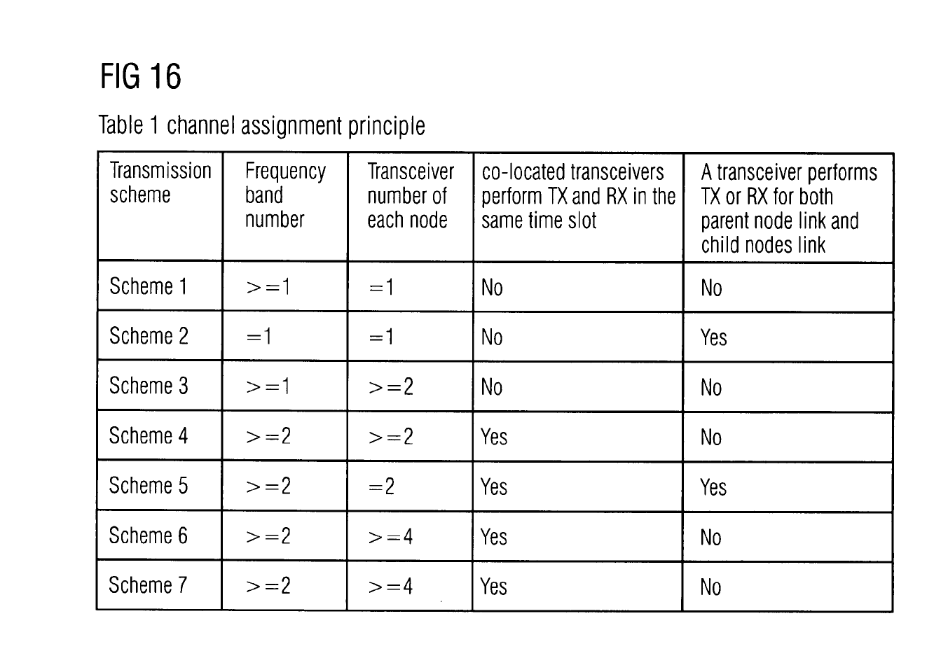

FIG. 16 illustrates a TABLE 1 which lists and identifies features of the seven transmission schemes.

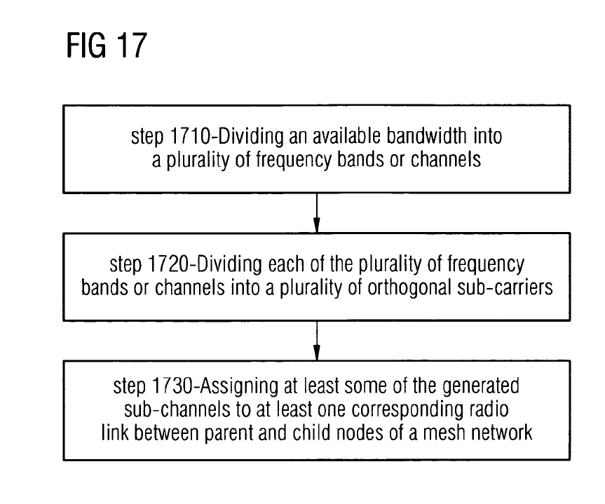

FIG. 17 illustrates a flow chart of steps which can be taken according to the exemplary embodiments of the invention. These steps include step 1710 of dividing an available bandwidth into a plurality of frequency bands dividing each frequency band into a plurality of orthogonal sub-carriers, step 1720 of organizing the sub-carriers into a plurality of sub-channels; and step 1730 of assigning at least some of the generated sub-channels to at least one corresponding radio link between parent and child nodes of a mesh network.

### DETAILED DESCRIPTION

The exemplary embodiments of this invention relate to mesh infrastructure network technology and, more specifically, address and solve the problem of how to best allocate available radio resources to different transceivers of mesh nodes in the frequency, time and spatial domains in order to maximize system throughput and spectrum re-use across the mesh network. While described herein primarily in the context of wireless mesh networks, it should be appreciated that these embodiments have a wider scope and may also be employed with, as non-limiting examples, IEEE 802.16m and similar systems, as well the LTE system.

The exemplary embodiments address and solve the problem noted above with respect to spectrum allocation for wireless mesh networks, where it was noted that the simple FDMA-based approach, as in current WiFi mesh networks, will not be adequate. Instead, it would be desirable to design the system to use an OFDMA-based approach, where more flexible re-use of OFDM sub-carriers can be enabled. In addition, the licensed spectrum may be given in discontinuous pieces, for example, at 3.4 GHz a spectrum of 7 MHz+7 MHz (two 7MHz frequency chunks) is allocated with a separation of 50 MHz in between.

Before describing in detail the exemplary embodiments of this invention it may prove useful to discuss in greater detail the some of the underlying technical issues that pertain to WMNs.

A non-limiting example of 2^{nd} mile wireless mesh network (WMN) 1 is shown in FIG. 1. In FIGS. 1, 21, 22, 23 designate mesh nodes 20 functioning essentially as wireless routers, where node 21 is the mesh node of 1 hop away from the root node 3, node 22 is the mesh node of 2 hops away from the root node 3, and node 23 is the mesh node of 3 hops away from the root node 3. The root node 3 is connected to a backbone network 10 through, for example, fiber, cable or a microwave link 11, and thus to some suitable infrastructure component(s) (IC) 12 that may be associated with a network operator. The root node 3 and the mesh nodes 21, 22, 23 are organized as a tree structure wherein mesh node 21 is the child node of root node 3 and, at the same time, is the parent node of mesh node 22. Similarly, mesh node 22 is the child node of the mesh node 21 and, at the same time, is the parent node of mesh node 23. Also shown are radio connections 4 between the mesh nodes. The traffic flows up and down through the branches of the mesh network 1. Traffic sent from a parent node to a child node is referred to herein for convenience as downlink

(DL) traffic, and the traffic sent from a child node to a parent node is referred to as uplink (UL) traffic.

The radio connections 4 exist between the mesh nodes 21, 22, 23 via directional antennas A1, A2, A3 and transceivers 20A, 20B, 20C, each operating with at least one controller 20D, such as at least one data processor operating in accordance with a stored program. The transceiver 20A-20C each operate at one of the frequencies fc1, fc2, fc3. Note that these exemplary embodiments are not limited for use with three transceivers, antennas, and frequencies. In general, and as will be discussed below, a given mesh node 20 may be constructed to have one, two, three, four or more transceivers and related components. Radio connections exist as well as between mesh nodes 21 and the root node 3. All data traffic and control information to and from individual mesh nodes 20 are routed through the root node 3 (connected with the high bandwidth backbone network 10). It can be appreciated that the traffic load is higher for those mesh nodes (21) closest to the root node 3, as the traffic for the other mesh nodes (22, 23) passes through them.

In the mesh network 1 radio connections 4 may be based on TDD. Some radio connections are point-to-point (PTP), while others may be point-to-multi-point (PMP). In the case where a transceiver (20A-20C) of the parent node 20 only connects with one child node the P2P mode is used. This means that the entire radio resource of the radio link is used between the parent node and children node. In the case where a transceiver of the parent node connects with more than one child nodes the PMP mode is used. This means that the radio link resource is shared between the child nodes.

The mesh network 1 may be used to provide data backhaul for wireless access infrastructure, such as WLAN AP, GSM

BTS, WCDMA NodeB and DVB-T BTS. By using this type of meshed backhaul network the operator is able to provide cost effective data backhauling for, as examples, a WBA system in a rural area or for a micro/pico BTS in an urban area.

In the case that the WMN 1 is used to provide backhauling for wireless access infrastructure, the network can be configured to use the same spectrum used by the wireless access infrastructure, or it can be configured to use a spectrum that is different from the spectrum used by wireless access infrastructure. Here one may denote the first case as “in-band backhauling” and the second case as “out-band backhauling”.

The mesh nodes 20 in the 2^{nd} mile WMN 1 may adopt a single or a multi-transceiver structure, or a hybrid of single and multi transceiver structures. The single transceiver structure implies that each mesh node 20 only has one radio transceiver (e.g., only the transceiver 20A and antenna element A1), and in this case the traffic exchanged between a parent node and a child node is based on the time domain sharing of the one transceiver. Considering the “out-band backhauling” case, four procedures are typically needed for one complete traffic exchange between the parent node and the child node. These four TX/RX procedures include: UL TX and DL RX with the parent node, and DL TX and UL RX with the child node. If the mesh node 20 is configured with one transceiver only, and the transceiver cannot perform TX and RX simultaneously, one complete data exchange can require four time phases. A relay node that realizes these four procedures in two physical layer time frames (or slots) using a single OFDM transceiver is described by Farooq Kahn, et al, “System and Method for Subcarrier Allocation in a Wireless Multihop Relay Network”, PCT/KR2006/001012, Mar. 20, 2006. One restriction here is that the relay node should perform DL RX with the parent node and UL RX with the child node in a same time slot using different OFDM sub-carriers of the same RF channel.*

To enable higher throughput per mesh node 20, the mesh node 20 may be designed to have more than one transceiver (e.g., as shown in FIG. 1). Here the multi-transceiver node 20 may support several simultaneous radio channels using multiple parallel RF front-end chips and possibly baseband processing modules. The channels may use orthogonal radio resources (frequency/sub-carrier/code), or may all use the same radio resource but in spatially different ways. On top of the physical layer there is a MAC layer to coordinate the TX and RX operation of multiple channels. Using the multiple transceivers (e.g., 20A-20C) the above mentioned four TX/RX procedures can be realized using two time phases (slots), or by using one time phase (slot). Through proper configuration and RF isolation design, the transceivers of the same node can realize simultaneous TX or RX using the same radio resource (frequency/sub-carrier/code) in different spatial directions.

Each mesh node 20 may be configured with an antenna array composed of several antenna elements, such as three 120-degree antenna elements, or six 60-degree antenna elements, to deliver 360-degree coverage. Each such sectorized antenna focuses radio signal energy in a specific direction, (e.g., 120 degree/60 degree horizontal beam) for greater signal strength, and thus achieves a significant longer range than an omni-directional antenna. The directional capabilities of the antenna array also permit more effective utilization of available spectrum by allowing simultaneous communication between nodes in neighboring areas.

In a mesh node 20 the number of radio transceivers may be the same as the number of antenna elements, or may be less than the number of antenna elements. In the latter case a baseband/RF switch can be used to configure the transceivers to the selected antenna elements that point in the directions according to the network topology requirement. To further avoid/reduce inter-node interference, which is the mutual interference between the nodes in the neighboring areas, proper orthogonal channels should be allocated for each radio link. In the 2^{nd} mile mesh network 1 shown in FIG. 1 each mesh node 20 is configured with the three transceivers 20A-20C, and is associated with a 3-sector antenna array. In this case three orthogonal channels are assigned for each link to avoid an occurrence of significant inter-node interference. In this example the orthogonal channels may be realized by using the three different frequency channels, fc1, fc2, fc3, in a FDMA mode. The mesh network topology and channel assignments may be controlled by a topology controller, which may be co-located in the root node 3, or remotely located in a separate server.

In general, a WMN can be operated as a synchronous mesh network or as an asynchronous mesh network. Operation of a synchronous mesh network implies that all transmission operations throughout the mesh topology are synchronized in the time domain. In contradistinction, operation of an asynchronous mesh network implies that all of the transmission operations can occur randomly in each mesh node. The 2^{nd} mile mesh network 1 may be assumed to be a synchronous wireless mesh network, although the scope of this invention is not restricted to only synchronous mesh networks. To implement a synchronous mesh network all mesh nodes 20 should synchronize to a common clock, which implies that additional devices and procedures to achieve and maintain time synchronization are included. For example, the use of GPS time can be employed.

As described earlier, the multi-channel scheme is used in the 2^{nd} mile mesh network 1 to avoid inter-node interference. Combined with directional antenna technology, effective spatial and spectral reuse can be realized. Multi-channel (i.e., multiple orthogonal channels) may be realized by using any of the well known multiple access techniques such as FDMA, TDMA, CDMA, OFDMA, or hybrids which use one or more of these techniques in combination.

As was noted above, FDMA is a common technique to realize a multi-channel scheme. In some existing WLAN-based mesh networks several RF channels are assigned to the neighboring mesh nodes either dynamically or statically, in order to avoid the potential inter-node interference. Reference in this regard may be made to “Mobile Backhaul from BelAir Networks”, BelAir Networks, 2007.

Advantages of the FDMA based multi-channel technique include:

A. The method can be used in an asynchronous mesh network.
B. For the mesh nodes 20 using multiple transceivers, the co-located transceivers never need to perform TX and RX at the same time using the same frequency band. Provided that the frequency band used by FDMA channels has sufficient adjacent channel guard band, it is possible to assign the frequency channels to the co-located transceivers, and avoid intra-node interference generated by co-located transceivers simultaneously performing TX and RX.

The disadvantages of FDMA-based multi-channel technique include:

A. Since the guard band is required between the FDMA-based multiple RF channels, a wide BW spectrum is needed to realize the multi-channel scheme. In particular, if the system requires a large number of channels it can in practice become difficult to deploy the wireless mesh network (each guard band consumes some amount of the available spectrum).
B. For the FDMA-based multi-channel scheme it can be typically the case that each channel has the same bandwidth. In a real wireless mesh system, a more dynamic resource allocation is desirable, e.g., to assign dynamically a wide bandwidth channel to a high throughput link and a narrow bandwidth channel to lower throughput link.
C. Since each mesh node can be configured with a multiple direction antenna array and multiple channels, it needs to perform radio link measurements in different antenna directions using different frequency channels in order to estimate radio link qualities towards the neighbor nodes. As a result, more time is required to obtain the required measurement results over multiple channels.

An OFDMA-based multi-channel scheme is shown in the FIG. 2. Using OFDMA the total available frequency band (or spectrum) is divided into N orthogonal sub-carriers, where N is the FFT/IFFT size used for OFDM symbols. In this case the multi-channel system can be realized through a proper combination of OFDM sub-carriers. This means that with N sub-carriers, the maximum of N sub-channels are available. According to actual network topology requirements, each radio link can then be allocated a different number of sub-carriers, and consequently a more flexible channel bandwidth allocation is realized.

The advantages of the OFDMA-based multi-channel technique include:

A. No guard band is needed between the multiple channels and, in theory, the frequency re-use equals unity.
B. Even with a single piece of radio spectrum, a high number of sub-channels can be realized through proper combination of the OFDM sub-carriers.
C. The sub-channel bandwidth (capacity) is flexible, simply by assigning a different number of OFDM sub-carriers to each radio link.
D. The radio link quality towards the other nodes is measured in the same RF channel (spectrum).

One challenge related to the implementation of the OFDMA-based multi-channel technique is the time delay between the desired signal and an interfering signal that uses a different sub-channel. Even in a synchronous mesh network the transmission delay between the interference signal and the desired signal can result in a misalignment between the sinusoid (sub-carrier) waveforms of different sub-channels, which must be aligned in order to be orthogonal to each other. To solve this problem a CP of suitable length can be added to allow the sub-carrier tones to be realigned in the receiver, and thus restore the orthogonality. However, the use of the CP decreases the proportion of the radio resource used for information transmission and increases system overhead.

For mesh/relay nodes configured with multiple transceivers, it is a significant advantage to allow a flexible combination of FDMA and OFDM based channel allocation schemes, where spectral usage is optimized by considering not only inter-node interference, which is the interference between different nodes, but also intra-node interference, which is the interference between co-located transceivers in the same node.

In present OFDMA-based multi-channel methods the approach focuses on a pure OFDMA-based multi-channel scheme in the wireless mesh/relay system using single transceiver mesh/relay nodes. Furthermore, the only consideration is the mesh/relay system being deployed over a single frequency band and a single RF channel. Prior to this invention, a hybrid FDMA and OFDMA based solution was not available.

As was explained above, in the WMN 1 a given mesh node 20 may contain multiple transceivers (e.g., 20A-20C) to support several simultaneous radio channels or sub-channels. The exemplary embodiments of this invention provide, at least in part, a sub-channel generation method based on a hybrid of the FDMA and OFDMA approaches. This beneficially enables the mesh network 1 to be deployed in different possible system spectrum scenarios, for example, unlicensed spectrum with more than one single RF channel or single frequency band, licensed FDD bands with more than one RF channels and/or with a flexible usage of uplink and downlink duplex RF channels, and/or TDD bands having more than one RF channel.

In the ensuing description various aspects of the exemplary embodiments are discussed. These include:

A. an orthogonal sub-channel generation method based on a hybrid of FDMA and OFDMA;
B. a hybrid FDMA and OFDMA based sub-channel assignment scheme for both single transceiver and multi-transceiver based mesh nodes 20; and
C. a hybrid FDMA and OFDMA based sub-channel assignment for both in-band backhauling and out-band backhauling networks.

The sub-channel assignment method may be used statically (i.e., sub-channels are pre-determined and assigned), or the sub-channel assignment method may be used dynamically as the network topology changes and/or the surrounding interference environment changes.

Described now in further detail are various aspects of sub-channel generation based on the hybrid FDMA and OFDMA techniques, and the principles of channel assignment, in the context of a number of different possible transmission schemes.

Reference may also be made to a related patent application entitled “Methods, Apparatuses, System, Related Computer Program Product and Data Structure for Network Management”. This document describes exemplary embodiments of a 2^{nd} mile mesh system architecture, and may be used in whole or in part for the implementation and use of the exemplary embodiments of the present invention.

Hybrid FDMA and OFDMA Sub-Channel Generation Method

As shown in FIG. 15, there are M frequency bands (or RF channels), where the center frequency of each frequency band (channel) is f1, f2, . . . fm. The guard band between neighborhood frequency bands or RF channels is denoted as G-band, and the bandwidth of each frequency band is denoted as B-band. To deploy the 2^{nd} mile mesh network 1 using this type of frequency allocation each frequency band is divided into N orthogonal sub-carriers, where N is the FFT/IFFT size used for OFDM modulation. The N sub-carriers in each frequency band are divided into Ki parts, and organized as Ki sub-channels. For the frequency band fi, and fj, the sub-channel number Ki and Kj can be the same or different. Each sub-channel can contain the same number of sub-carriers or it may contain a different number of sub-carriers. The sub-carriers are further assigned to a sub-channel in sequence or in a random or pseudorandom order. Consequently, for the frequency band f1, f2, fm, N=k1+k2+Y km sub-channels are generated.

As described above, a mesh node needs two TX and two RX operations to complete one traffic exchange between a parent node and its child node. These four different phases of the operation include: UL TX and DL RX with the parent node, and DL TX and UL RX with child node. Below are summarized seven basic schemes or techniques or approaches to realize these four phases of operation:

Scheme 1: 4-phase transmission using single transceiver;

Scheme 2: 2-phase transmission using single transceiver;

Scheme 3: multiple transceiver based 2-phase transmission, type 1;

Scheme 4: multiple transceiver based 2-phase transmission, type 2;

Scheme 5: 1-phase transmission using multiple transceivers, type 1;

Scheme 6: 1-phase transmission using multiple transceivers type 2, and

Scheme 7: 1-phase transmission using multiple transceivers type 3.

Among these seven schemes, schemes 1 and 2 are used for mesh nodes 20 with a single transceiver, and schemes 3, 4, 5, 6 and 7 are used for mesh nodes 20 with multiple transceivers. Note that schemes 6 and 7 may require more than four transceivers in the mesh nodes.

Transmission Scheme 1: 4-Phase Transmission Using Single Transceiver

FIG. 3 shows a transmission example of the mesh node 20 configured with one radio transceiver (e.g., 20A), where a TDD radio frame is used. Node1 is the parent node of node2, and node2 is the parent node of node3. The TDD frame is equally divided into four time phases that are allocated for the transmission from node1 to node2, from node2 to node3, from user node3 to node2, and from node2 to node1, in turn, as illustrated in FIG. 3. Since the four transmissions can have different orders in combination, the wireless mesh network 1 can adopt any of the combinations to realize data exchange according to system requirement.

A similar principle can be readily extended to the wireless mesh network where the maximum number of hops is larger than two. One example is shown in FIG. 4. Here, the two phases of TX and two phases of RX are performed separately. Therefore, for a mesh node 20 there is no interference between these four procedures. This means in theory that a particular node 20 can complete the four communication procedures using the same sub-channels. In such a wireless mesh network one need consider the interference between different mesh nodes 20. One potential drawback to this approach, however, is that the mesh nodes 20 operate in half-duplex mode, i.e., they cannot simultaneously transmit and receive thereby reducing system throughput.

Transmission Scheme 2: 2-Phase Transmission Using Single Transceiver

As shown in FIG. 5, a 2-phase transmission protocol is used. A TDD radio frame is equally divided into two time slots. In the first time slot, nodel transmits s1 to the mesh node2, and the node3 transmits s2 to the mesh node2. To avoid interference between the two signals, s1 and s2 use different orthogonal sub-channels. In the second time slot, mesh node2 broadcasts s1+s2 to node1 and node3. Since s1 and s2 are known to node1 and to node3, respectively, they can perform self-interference cancellation and correctly obtain the s2 and s1 information, respectively. Alternatively, mesh node2 sends s1 to mesh node 3 and s2 to mesh node 1 using different orthogonal sub-channels. Here node 2 functions in a manner analogous to a BTS connected to multiple terminals. A similar principle can be readily extended to the wireless mesh network 1, where the maximum number of hops is larger than two. As shown in FIG. 6, during one time slot the transceivers of even hop nodes perform TX while all odd hop nodes perform RX. In the subsequent time slot, all of the odd hop nodes perform RX while all of the even hop nodes perform TX, and so on.

In this approach the transceiver only performs a single task in any one time slot: TX or RX. Therefore it is not necessary to assign different sub-channels of sufficient duplex bandwidth for TX and RX procedures to a node. At the same time data forwarding/relaying across the network 1 is achieved through the TX and RX alternation between the even hop nodes and odd hop nodes. Since a single transceiver cannot perform TX or RX in different bands, all of the transceivers should work in the same band. However, a node must receive signals from the parent node and from child nodes in one time slot, and similarly the node must transmit signals to the parent node and child nodes in the following time slot. To avoid interference between the parent node signal and the child node signal, the mesh node 20 preferably uses different sub-channels on the radio links connecting each parent node and child node.

FIG. 6 also illustrates an example of a sub-channel assignment for scheme 2. SC1 (sub-channel 1), SC2 (sub-channel 2) and SC3 (sub-channel 3) are generated based on OFDMA as described earlier. That is, SC1, SC2 and SC3 are generated from the sub-carriers of the same OFDM symbol bandwidth (or RF channel). SC1, SC2 and SC3 are assigned to the corresponding radio links in order to ensure proper system operation and avoid the inter-node interference.

Transmission Scheme 3, Multiple Transceivers Based 2-Phase Transmission, Type 1

As is shown in FIG. 7, in the multi-transceiver based 2-phase transmission type 1 the node 2 is the intermediate node. The transceivers of the node 20 are divided into two groups, i.e., the transceivers connecting with the parent node and the transceivers connecting with child nodes. In the first time slot, all of the transceivers of node2 perform RX and receive packets from the neighbor nodes, such as the node1 and node 3 illustrated in FIG. 7. In the following time slot all of the transceivers of node2 perform TX and transmit packets to the neighbor nodes, node1 and node3 in this example. Due to the signal processing delay, which includes time needed for encoding, decoding, and packet scheduling, the packet received in the first slot typically cannot be sent immediately in the following slot within one physical layer frame. Instead, it may be expected that about 0.5-1 frame times are needed for packet processing before the receiving node can transmit the packet to the next node.

It is possible to construct a multi-hop radio system, where the maximum hop number is larger than two and the network is organized in a tree topology, as shown in FIG. 8, by using the principles embodied in scheme 3 (FIG. 7). Here, the mesh/relay nodes 20 are divided as even hop nodes and odd hop nodes, which are determined by the hop number from the root node 3 of the tree topology. In one time slot all of the transceivers of even hop nodes perform TX while all the transceivers of odd hop nodes perform RX. In the subsequent time slot, all of the transceivers of odd hop nodes perform RX while all the transceivers of even hop nodes perform TX, and so on. From FIG. 8 it can be seen that for all the transceivers to connect with the parent nodes, there is half slot phase difference between the odd and even hop nodes.

Similarly, for all the transceivers to connect with the child node there is half frame phase difference between the odd and even hop nodes. Since the mesh network 1 is organized so as to exhibit the tree topology, a parent node can have more than one child node. For the parent node with multi-transceivers (20A-20C), some transceivers may only be used to connect with one child node and some transceivers may be used to connect with more than one child node. For the first case the P2P connection is used while for the second case the PMP connection is used. This implies that the radio link resource is shared between the child nodes. The PMP connection is realized by use of a suitable multiple access technique.

One advantage of scheme 3 is that each node 20 only performs either transmit or receive on the different transceivers 20A-20C during any one time slot. Consequently with sufficient RF (spatial) isolation, any significant interference between different transceivers of the same node can be avoided. This ensures high throughput performance of the mesh/relay nodes 20, even if the co-located transceivers operate in the same frequency band/same sub-channel. This feature is one significant distinction between the scheme 2 and scheme 3.

Note that in the transmission scheme 3, to make the input and output data flow match, the TDD frame can only support a symmetrical UL and DL in the multi-hop network. Second, and more fundamentally, note that a complex adjustment procedure may be needed when the mesh network topology changes, such as when an even hop node is changed to an odd hop node, and vice versa. Due to the (typical) signaling process delay of from about 0.5 to 1 frame, for scheme 3 the minimum one hop delay is 1.5 frames.

Transmission Scheme 4: Multiple Transceivers Based 2 Phase Transmission, Type 2

Transmission scheme 4 does not suffer from the above noted limitations of scheme 3. As is shown in FIG. 9, in scheme 4 the intermediary node, node2, receives a packet from node1 while using another transceiver to transmit a packet to node3. In the next time slot node2 transmits a packet to node1, while using the other transceiver to receive a packet from node3. As in scheme 3, due to the inherent processing delay the packet received in one time slot usually cannot be sent in the following time slot within one physical layer radio frame (assume as the non-limiting case that about 0.5-1 frame is needed for packet processing).

Furthermore, scheme 4 may be extended to a multi-hop radio system where the maximum hop number is larger than two. Here, the mesh/multi hop network is organized so as to exhibit the tree topology, as shown in FIG. 10a, with all of the transceivers connecting child nodes as well as all of the transceivers connecting the parent node, being synchronized. This implies that the transceivers connecting parent node/child nodes perform TX/RX within the same time slot.

One potential issue with the use of the scheme 4 is an occurrence of self-interference among the transceivers 20A-20C within the same mesh node 20. To avoid interference between co-located transceivers that perform TX and RX simultaneously, the transceivers connected with child nodes and the transceivers connected with parent node should in principle operate in different frequency channels, and between these channels there should exist sufficient duplex space. This implies that a larger spectrum/channels be available for the system deployment.

An example where scheme 4 is deployed in a FDD spectrum is shown in FIG. 10b. In FIG. 10b, f1 and f2 have sufficient duplex guard band (G-band). In this case f1 and f2 are assigned to mesh nodes in even hop and odd hop alternation as illustrated.

The use of scheme 4 has several advantages relative to scheme 3. Firstly, with the node architecture of scheme 4 the minimum delay of each hop is one frame, which is less than that of scheme 3. Secondly, in scheme 4 the TDD frame can support asymmetric uplink and downlink transmissions in a multi-hop network. Furthermore, when the network topology changes, there is no need to adjust the transmission phase because phase synchronization is maintained between the transceivers.

Transmission Schemes 5, 6, 7: 1-Phase Transmission With Multi-Transceivers Type 1, 2 ,3

FIG. 11 illustrates 1-phase transmission using multiple transceivers, type 1. The transceivers 20A-20C of the nodes 20, as similarly identified in FIG. 1, are again divided into two groups, and some transceivers function as a receiver and others function as transmitters. The transmitters are used to send a data packet to the parent node and child nodes, and the receivers are used to receive a data packet from the parent node and child nodes. To avoid interference between the co-located transmitter and receiver they are assigned to use different RF channels f1 and f2. Between f1 and f2 there is provided a sufficient duplex guard band. As in scheme 2, scheme 5 differentiates the signals coming from or sent to the corresponding child nodes and parent node. Sub-channels SC1, SC2 and SC3 from RF channel f1 are used to avoid interference for the receivers, and sub-channels SC4, SC5, SC6 from RF channel f2 are used to avoid interference for the transmitters. To realize the transmission scheme 5, a minimum of two RF channels are needed.

One advantage of the use of transmission scheme 5 is that although each radio link performs UL and DL in one time slot, in theory a minimum of two transceivers are needed for each radio link with a child node, and a minimum of two transceivers are needed for each radio link with the parent node. However, through proper frequency assignment scheme 5 can realize the TX radio link to the parent node and child nodes using one transmitter, and similarly it can realize the RX radio link to the parent node and child nodes using a single transmitter. To realize scheme 5 a minimum of two transceivers are needed. Note that multiple sub-channels are used for the transmitters and receivers in order to differentiate the signals sent to or received from different nodes.

Scheme 6 and scheme 7 realize 1-phase transmission using multi-transceivers. Scheme 6 is shown in FIG. 12, and scheme 7 is shown in FIG. 13. Differing from the scheme 5, both scheme 6 and scheme 7 use two transceivers to realize the radio link with the parent node: i.e., a transmitter for the parent node and a receiver for the parent node. Similarly, both schemes 6 and 7 use two transceivers to realize the radio link with the child node: i.e., a transmitter for the child node and a receiver for the child node. Consequently, each mesh node 20 in these embodiments include at least has four transceivers.

One advantage that is realized by the use of scheme 6 and scheme 7 is that with sufficient RF (spatial) isolation, any significant amount interference between different transceivers of the same node 20 can be avoided. This ensures high throughput performance of the mesh/relay node 20, even if the co-located transceivers operate in the same frequency band/same sub-channel.

Discussed now are various principles related to channel assignment for the above seven transmission schemes.

As described above, there are at least two dimensions for generating a sub-channel based on the hybrid FDMA and OFDMA techniques. Dimension 1 is the sub-channels from different frequency bands (or RF channels), and dimension 2 is the sub-channel containing different sub-carriers of the same RF channel.

For a radio link connecting with other nodes, the radio link may be divided into two types: a) parent link, which is used to connect a node 20 to its parent node, and b) child link, which is used to connect the node 20 to its child node(s). The mesh node 20 preferably avoids the interference between these parent link and child links through proper sub-channel assignment. For a mesh node 20 with multiple transceivers, channel assignment should also be such that it avoids the interference between the co-located transceivers of the node.

Specific sub-channel assignment principles are followed along the two dimensions in order to avoid the interference between child links and the parent link, as well as the potential interference between co-located transceivers of the same node. Several of these principles are outlined as below.

A. If the co-located transceivers perform TX and RX in the same time slot, the transceivers should use the sub-channel from different frequency bands (or RF channels), which have a sufficient guard band for duplex operation, even there exists a large RF (spatial) isolation between the transceivers.

B. If a given transceiver performs TX or RX both for parent link and for the child link, then different sub-channels are preferably used for the parent link and child link

C. If sufficient RF (spatial) isolation exists between the transceivers, then the transceivers that perform TX or RX may be assigned the same sub-channel for the same time slot.

D. Since the mesh network 1 may often be organized so as to exhibit the tree topology, a parent node can have more than one child node. For the parent node with multi-transceivers, and in the case where several transceivers are used for child links, the same sub-channel may be assigned to different transceivers, provided that sufficient RF (spatial) isolation exists between the transceivers.

E. For the parent node with multi-transceivers, some transceivers may only be used to connect with one child node and some transceivers may be used to connect with more than one child node. In the first case the P2P connection is used, and in the second case the PMP connection is used. This implies that the radio link resource, which is represented by the sub-channels assigned to the radio link, is further shared among the child nodes. The PMP connection is realized by corresponding multiple access techniques, such as FDMA or OFDMA.

The principles discussed above consider at least in part how to avoid intra-node interference, as well as the interference between the parent link and child links of the same node. They may thus be viewed as representing fundamental methods to ensure that a given instance of the mesh network 1 will function properly without generating significant interference.

The features of the seven transmission schemes are further listed in Table 1 shown in FIG. 16.

In transmission scheme 1 the parent link and child links are in different time slots, and a single transceiver cannot perform TX and RX at the same time. Therefore, the sub-channels can be generated using either a single frequency band (or RF channel), or multiple frequency bands (or RF channels). The sub-channels can be fully re-used in every time slot.

In the transmission scheme 2 a transceiver performs TX for both the parent link and child link in one time slot, and the transceiver performs RX for both the parent link and child link in the following time slot. Since a mesh node 20 in this case has only a single transceiver, the transceiver cannot perform TX and RX in the same time slot. The sub-channels here can be generated using a single frequency band (or RF channel). For the radio links of the mesh node 20 different sub-channels are used to distinguish the parent link and child links in the TX time slot and/or in the RX time slot.

In the transmission scheme 3 the mesh node 20 provides parent link and child link connections using different transceivers. In one time slot all of the transceivers perform TX, and in the following time slot all of the transceivers perform RX. If sufficient RF (spatial) isolation exists between the transceivers, the transceivers may use the same sub-channel. For scheme 3 the sub-channels can be generated using a single frequency band (RF channel) or multiple frequency bands (or RF channels). The sub-channels can be fully reused in each and every time slot.

In the transmission scheme 4 TX and RX are performed in the parent link and child link by different transceivers in one time slot. Therefore, sub-channels are preferably generated using more than two frequency bands (or RF channels). In addition, the sub-channels generated by different frequency bands (or RF channels) are assigned to the parent link and the child link separately.

In the transmission scheme 5 a mesh node 20 is configured with two transceivers, one for the transmitter and the other for the receiver. In one time slot a transceiver performs TX for both the parent link and for the child link, while the other transceiver performs RX for both the parent link and for the child link. Therefore, the sub-channels are generated using more than two frequency bands (or RF channels). In addition, the sub-channels generated by different frequency bands are assigned to the transmitter and to the receiver, respectively. Different sub-channels are used to distinguish the parent link and child links in the transmitter and the receiver.

In the transmission schemes 6 and 7 a mesh node 20 can be configured with at least four transceivers. The at least four transceivers operate as the transmitter in the parent link, the receiver in the parent link, the transmitter in the child link, and the receiver in the child link, respectively, and operate simultaneously. Therefore, the sub-channels are generated by using more than two frequency bands. In addition, the sub-channels generated by different frequency bands are assigned to the transmitter and the receiver, respectively. If sufficient RF (spatial) isolation exists between the transmitters for the parent link and child link, and sufficient RF (spatial) isolation also exists between the receivers for the parent link and child link, then the transceivers can be assigned the same sub-channel.

To further avoid the inter-node interference, which is the interference between neighbor mesh nodes 20, additional sub-channels may be used. A sub-channel is assigned to each radio link accordingly to avoid intra-node interference, as well as according to the channel assignment algorithm to avoid inter-node interference.

There are at least two channel assignment methods that can be used to avoid the inter-node interference, one is according to radio planning, the other is a topology based channel assignment method. The radio planning method is analogous to cell planning in a cellular radio access system. That is, the sub-channels are assigned according to the mesh node location and radio propagation environment, a different sub-channel is assigned for neighbor mesh nodes to avoid potential interference, and the sub-channel can be reused between mesh nodes that are well spatially separated. The topology based channel assignment method assigns the sub-channels according to the mesh network topology. In this case the inter-node interference is measured by a mesh node 20 and an algorithm is used to calculate and to propose the orthogonal sub-channels to be assigned to the radio links accordingly.

Discussed now is the hybrid FDMA and OFDMA based sub-channel assignment for an in-band backhauling system. In the case that a mesh network 1 is used to provide backhaul for wireless access infrastructure, the mesh network can be configured to the spectrum used by the wireless access infrastructure, or it can be configured to use another spectrum different from that used by the wireless access infrastructure. As was briefly discussed above, the first case may be referred to as “in-band backhauling” and the second case as “out-band backhauling”.

The seven transmission schemes discussed above are primarily concerned with out-band backhauling. For the in-band backhauling case one should consider the fact that the same radio resource is used both by the access network and for backhauling. In general, to realize the access segment of the communication system two procedures are applied. In the first procedure the user equipment (UE), such as a mobile terminal, sends a packet to a BTS in the UL, and the BTS sends a packet to the UE in the DL. These two procedures can be realized either by TDD, which uses two time slots (one for the UL and one for the DL) or, alternatively, by FDD which implements the UL and DL operations using two separate frequency bands.

For in-band backhauling the access and backhauling can share the same radio resource using different time slots, or by using different sub-channels. Described now is an in-band backhauling scheme for a case where the access and backhauling use different time slots.

As shown in FIG. 14 an in-band backhauling frame includes two time slots, where one time slot is used for the network access part and the other time slot is used for backhauling. In the case that the access part operates in the TDD mode the time slot used for the access part is further divided into two parts, one for DL transmission and the other for the UL transmission. In a case where the access part operates in the FDD mode the UL and DL transmissions occur in the same access time slot, but are separated by the use of different frequency bands. Consequently, the frequency band used for the access part may be the same as the frequency band used for the backhauling part. Note that in the backhaul slot portion any one of the seven transmission schemes discussed above may be used.

Based on the foregoing it should be apparent that the exemplary embodiments of this invention provide a method, apparatus and computer program product(s) to provide a hybrid FDMA/OFDMA subchannel generation technique for use in wireless mesh networks, including both synchronous and asynchronous mesh networks, and further including both in-band and out-band backhaul wireless mesh networks.

Further, based on the forgoing it can be understood that the exemplary embodiments of the invention can include the features at least described in the flow chart illustrated in FIG. 17. These steps of FIG. 17 can include step 1710 of dividing an available bandwidth into a plurality of frequency bands or channels, dividing each of the plurality of frequency bands or channels into a plurality of orthogonal sub-carriers, step 1720 of organizing the sub-carriers into a plurality of sub-channels; and step 1730 of assigning at least some of the generated sub-channels to at least one corresponding radio link between parent and child nodes of a mesh network.

In accordance with the exemplary embodiments of the invention there is at least a method, apparatus, and computer program configured to divide an available bandwidth into a plurality of frequency bands, divide each frequency band into a plurality of orthogonal sub-carriers, organize the sub-carriers into a plurality of sub-channels, and assign at least some of the generated sub-channels to at least one corresponding radio link between parent and child nodes of a mesh network.

In addition to the above paragraph the exemplary embodiments of the invention can relate to where each sub-channel contains one of a same number of sub-carriers and a different number of sub-carriers.

Further, in addition to the above paragraphs, the exemplary embodiments of the invention can relate to where the sub-carrier signals are organized into the plurality of sub-channels in one of a sequence order, a random order, and a pseudorandom order.

The method, apparatus, and computer program of the preceding paragraphs where the exemplary embodiments include inserting a guard band between each of the plurality of sub-channels.

The method, apparatus, and computer program of the preceding paragraphs where the parent and child nodes perform transmitting and receiving in a same time slot, then assigning sub-channels from different frequency bands for use in each of the corresponding radio links, where the assigned sub-channels include a sufficient guard band for duplex operation.

The method, apparatus, and computer program of the preceding paragraphs where a given node transmits and receives as both the parent node and the child node using different ones of the sub-channels.

The method, apparatus, and computer program of the preceding paragraphs in which a same sub-channel is assigned to both the parent node and the child node for use in a same time slot.

The method, apparatus, and computer program of the preceding paragraph where the at least one corresponding radio link is one of a point-to-multipoint connection

In accordance with the exemplary embodiments of the invention the method, apparatus, and computer program, as in any of the preceding paragraphs, including assigning a first generated sub-channel to a radio link between a root node and a first hop node, and assigning a second generated sub-channel to a radio link between the first hop node and a second hop node.

The method, apparatus, and computer program of the preceding paragraphs further including assigning a third generated sub-channel to the radio link between the first hop node and the second hop node.

Further, in addition to the above paragraphs, the exemplary embodiments of the invention can relate to where the assigned generated sub-channels are used by the first hop node to transmit a signal to the second hop node in a first time slot, and to receive a signal from the second hop node in a second time slot.

In accordance with the exemplary embodiments of the invention the method, apparatus, and computer program, as in any of the preceding paragraphs including assigning more than one generated sub-channel to at least one radio link between a first hop node and at least one other node, where the first hop node comprises more than one transceiver.

Further, in addition to the above paragraphs, the exemplary embodiments provide where each transceiver of the more than one transceivers of the first hop node can use at least one of the sub-channels to one of transmit to or receive from, in a particular time slot, the at least one other node.

In addition to the above paragraph, where the more than one transceiver comprises at least one transceiver assigned to be a receiver and at least one transceiver assigned to be a transmitter, and where sub-channels assigned to the receiver are different that sub-channels assigned to the transmitter.

The method, apparatus, and computer program, as in any of the preceding paragraphs for a case of an in-band backhauling or relaying communication in the mesh network, further comprising assigning a first generated sub-channel to the an access node in the mesh network, and assigning a second generated sub-channel to a backhauling node in the mesh network.

The method, apparatus, and computer program, as in any of the preceding paragraphs where the assigned first and second generated sub-channels share a same radio resource and where the in-band backhauling or relaying communication includes a first and second time slot, comprising transmitting, by one of the backhauling or the access node, a signal to the other node in the first time slot using the same radio resource, and subsequently, receiving, from the other node, a signal in the second time slot using the same radio resource.

The method, apparatus, and computer program, as in any of the preceding paragraph, where the in-band backhauling or relaying communication includes a first time slot and where the access node is operating in a time division duplex mode, comprising dividing the first time slot into a first part and a second part, and transmitting, by the access node, on an uplink in the first part and on a downlink in the second part of the first time slot.

The method, apparatus, and computer program, as in any of the preceding paragraph, where the access node is operating in a time division duplex mode and where the assigned first and second generated sub-channels are each generated from different frequency bands of the plurality of frequency bands, comprising transmitting, by one of the access node or the backhauling node, on an uplink using the first generated sub-channel, and transmitting, by one of the access node or the backhauling node, on a downlink using the second generated sub-channel.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, system architecture model depictions or by using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of prestored design modules. Once the design for a semiconductor circuit has been completed, the resultant design, in a standardized electronic format may be fabricated as one or more integrated circuit devices.

The exemplary embodiments of this invention may thus be realized at least in part by an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of various types of WMN topologies with various types of mesh node architectures (including numbers of transceivers and antenna elements) it should be appreciated that the exemplary embodiments of this invention are not limited for use with only these particular examples of type of wireless communication systems, and that they may be used to advantage in other types of wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for any described parameters, channels and the like are not intended to be limiting in any respect, as these parameters, channels and the like may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1-36. (canceled)

37. A method, comprising:
dividing an available bandwidth into a plurality of frequency bands or channels;
dividing each of the plurality of frequency bands or channels into a plurality of orthogonal sub-carriers;
organizing the sub-carriers into a plurality of sub-channels; and
assigning at least one of the sub-channels to at least one corresponding radio link between parent and child nodes of a mesh network.

38. The method according to claim 37, where each of the sub-channels contain one of a same number of sub-carriers and a different number of sub-carriers and where the sub-carriers are organized into the plurality of sub-channels in one of a sequence order, a random order, and a pseudorandom order.

39. The method according to claim 37, where the parent and child nodes perform transmitting and receiving in a same time slot, and comprising assigning the sub-channels from different frequency bands for use in each of the at least one corresponding radio link, where the assigned sub-channels include a sufficient guard band for duplex operation.

40. The method according to claim 37, where a given node transmits and receives as both the parent node and the child node using different ones of the sub-channels and where a same sub-channel is assigned to both the parent node and the child node for use in a same time slot.

41. The method according to claim 37, where assigning comprises:
assigning a first generated sub-channel to a radio link between a root node and a first hop node; and subsequently
assigning a second generated sub-channel to a radio link between the first hop node and a second hop node, where the assigned generated sub-channels are used by the first hop node to transmit a signal to the second hop node in a first time slot, and to receive a signal from the second hop node in a second time slot.

42. The method according to claim 37, comprising assigning more than one of the sub-channels to at least one radio link between a first hop node and at least one other node, where the first hop node comprises more than one transceiver, where each transceiver of the more than one transceivers of the first hop node can use at least one of the sub-channels to one of transmit to or receive from the at least one other node in a particular time slot and where the more than one transceiver comprises at least one transceiver assigned to be a receiver and at least one transceiver assigned to be a transmitter, and where sub-channels assigned to the receiver are different than sub-channels assigned to the transmitter.

43. A memory embodying a computer program executable by a processor to perform the method of claim 37.

44. The method according to claim 37 for an in-band backhauling or relaying communication in the mesh network, comprising:
assigning a first generated sub-channel to the an access node in the mesh network; and
assigning a second generated sub-channel to a backhauling node in the mesh network.

45. The method according to claim 44, where the assigned first and second generated sub-channels share a same radio resource and where the in-band backhauling or relaying communication includes a first and second time slot, comprising:
transmitting, by one of the backhauling or the access node, a signal to the other node in the first time slot with the same radio resource; and
subsequently, receiving from the other node, a signal in the second time slot with the same radio resource.

46. The method according to claim 44, where the in-band backhauling or relaying communication includes a first time slot and where the access node is operating in a time division duplex mode, comprising:
dividing the first time slot into a first part and a second part; and
transmitting, by the access node, on an uplink in the first part and on a downlink in the second part of the first time slot.

47. The method according to claim 44, where the access node is operating in a time division duplex mode and where the assigned first and second generated sub-channels are each generated from different frequency bands of the plurality of frequency bands, comprising:
transmitting, by one of the access node or the backhauling node, on an uplink using the first generated sub-channel; and
transmitting, by one of the access node or the backhauling node, on a downlink using the second generated sub-channel.

48. An apparatus, comprising:
a processor configured to divide an available bandwidth into a plurality of frequency bands or channels;
the processor configured to divide each of the plurality of frequency bands or channels into a plurality of orthogonal sub-carriers;
the processor configured to organize the sub-carriers into a plurality of sub-channels; and
the processor configured to assign at least one of the sub-channels to at least one corresponding radio link between parent and child nodes of a mesh network.

49. The apparatus according to claim 48, where each sub-channel contains one of a same number of sub-carriers and a different number of sub-carriers and where the sub-carriers are organized into the plurality of sub-channels in one of a sequence order, a random order, and a pseudorandom order.

50. The apparatus according to claim 48, where the parent and child nodes perform transmitting and receiving in a same time slot, and comprising the processor is configured to assign sub-channels from different frequency bands to each of the at least one corresponding radio link, where the assigned sub-channels include a sufficient guard band for duplex operation.

51. The apparatus according to claim 48, where a given node is configured to transmit and receive as both the parent node and the child node using different ones of the sub-channels and where the processor is configured to assign a same sub-channel to both the parent node and the child node for use in a same time slot.

52. The apparatus according to claim 48, where assigning comprises:
the processor is configured to assign a first generated sub-channel to a radio link between a root node and a first hop node; and
the processor is configured to assign a second generated sub-channel to a radio link between the first hop node and a second hop node, where the assigned generated sub-channels are used by the first hop node to transmit a signal to the second hop node in a first time slot, and to receive a signal from the second hop node in a second time slot.

53. The apparatus according to claim 48, comprising the processor is configured to assign more than one of the sub-channels to at least one radio link between a first hop node and at least one other node, where the first hop node comprises more than one transceiver, where each transceiver of the more than one transceivers of the first hop node can use at least one of the sub-channels to one of transmit to or receive from the at least one other node in a particular time slot and where the more than one transceiver comprises at least one transceiver assigned to be a receiver and at least one transceiver assigned to be a transmitter, and where sub-channels assigned to the receiver are different than sub-channels assigned to the transmitter.

54. The apparatus according to claim 48, for a case of an in-band backhauling or relaying communication in the mesh network, further comprising:
the processor is configured to assign a first generated sub-channel to the an access node in the mesh network; and
the processor is configured to assign a second generated sub-channel to a backhauling node in the mesh network.

55. The apparatus according to claim 54, where the in-band backhauling or relaying communication includes a first time slot and where the access node is operating in a time division duplex mode, comprising:
the processor configured to divide the first time slot into a first part and a second part; and
assigning the first part to be used by the access node in an uplink transmission and the second part to be used by the access node in a downlink transmission.

56. The apparatus according to claim 54, where the access node is operating in a time division duplex mode and where the assigned first and second generated sub-channels are each generated from different frequency bands of the plurality of frequency bands, comprising:
transmitting, by one of the access node or the backhauling node, on an uplink using the first generated sub-channel; and
transmitting, by one of the access node or the backhauling node, on a downlink using the second generated sub-channel.
